(19) United States
(12) Patent Application Publication
(10) Pub. No.: US 2024/0371122 A1
(43) Pub. Date: Nov. 7, 2024

(54) SYSTEMS AND METHODS FOR SCANNING CONCEALED OBJECTS

(71) Applicant: VAYYAR IMAGING LTD., Yehud (IL)

(72) Inventors: Roy ILANI, Jerusalem (IL); Matan BIRGER, Kefar Malal (IL); Tsachi ROSENHOUSE, Kiryat Ono (IL); Shay MOSHE, Petach-Tikva (IL)

(21) Appl. No.: 18/762,814

(22) Filed: Jul. 3, 2024

Related U.S. Application Data
(63) Continuation-in-part of application No. 18/682,148, filed on Feb. 8, 2024.
(60) Provisional application No. 63/230,751, filed on Aug. 8, 2021.
(60) Provisional application No. 63/317,992, filed on Mar. 9, 2022.
(60) Provisional application No. 63/524,869, filed on Jul. 4, 2023.

(51) Int. Cl. G06V 10/26; G06V 10/77; G06V 10/82; G06V 20/52

(52) U.S. Cl. CPC G06V 10/267; G06V 10/7715; G06V 10/82; G06V 20/52

(57) ABSTRACT

Systems and methods for scanning concealed surface and detecting concealed objects using a radar that transmits electromagnetic radiations towards a subject receives the reflected electromagnetic signals, a processing unit that receives raw complex image data from the radar unit and processes the data using a complex convolution neural network to detect concealed objects, a display unit that displays images representing the concealed object, a database that stores the processed data along with the raw complex image and the processed image data to train the processing unit to detect specific concealed objects, and a communicator that transmits notifications through a communication network.

### CROSS-REFERENCE TO RELATED APPLICATIONS

This application is a continuation in part of U.S. patent application Ser. No. 18/682,148 which was filed Feb. 8, 2023, as a U.S. National Phase Application under 35 U.S.C. 371 of International Application No. PCT/IB2022/057366, which has an international filing date of Aug. 8, 2022, and which claims the benefit of priority from U.S. Provisional Patent Application No. 63/230,751, filed Aug. 8, 2021, and U.S. Provisional Patent Application No. 63/317,992, filed Mar. 9, 2022, the contents of which are incorporated by reference in their entirety.

This application further claims the benefit of priority from U.S. Provisional Patent Application No. 63/524,869, which was filed Jul. 4, 2023.

### FIELD

The invention relates generally to systems and methods for scanning and detecting concealed objects. In particular, systems and methods are described for providing imageless and walk-through security scanners using a radar system and detecting concealed objects while providing privacy to the subject being scanned.

### BACKGROUND

Concealed object detection can be a challenge for law enforcement and security purposes. Handheld metal detectors are being used for the detection of hidden objects, e.g. objects such as weapons or metal objects concealed within the person's clothing or shoes, within packages or other opaque outer layers. However, metal detectors only detect metallic objects, furthermore they do not typically provide imaging data to indicate the shape or nature of the object detected. Such known screening methods can be ineffective in preventing some concealed objects from being detected, especially if they are made of plastic or liquid materials, for example.

Another known acoustic/ultrasonic detection systems uses acoustic/ultrasonic transducers to convert the electrical signal into an acoustic/ultrasonic signal and transmit the signal towards the object in the target area which is received and converted back to the electrical signal for processing.

Other known screening systems can use, for example, low level backscatter X-rays, chemical trace detection, etc. Some of these screening technologies, for example, those that employ ionizing radiation, may not be acceptable in some circumstances because they can be deemed to be harmful, especially for children, pregnant women, and elderly people. Consequently, x-rays devices are not suitable for walk-through scanners.

Full body scanners typically require a scanner to be rotated about the scanned subject so as to expose the whole of the surface of the subject to scanning radiation. Alternatively, the subject may rotate relative to the scanner. This can be time consuming and cumbersome. Practically this may limit the number of subjects that may be scanned particularly in security situations such as airports and the like where large numbers of subjects.

Walk-through scanners are a useful alternative to handheld scanners as they may allow individuals to be scanned in an unobtrusive manner and in a natural way as they proceed along a required path. Some radar based walk-through scanners are described in the applicant's co-pending U.S. patent application Ser. No. 17/642,213 and international application number PCT/IB2022/057366, however in order to acquire clear images of moving objects a radar scanner requires a shorter scan time than is typically possible.

The problem of theft in production establishments like factories and warehouses is a major problem for the management. The use of cameras and video recorders provides help to a limited extent and does not effectively catch a person hiding a small object like a watch in his/her clothes.

The use of known concealed object detection systems have their limitation due to the size, shape, composition and configuration of the object. Further, these systems cannot be configured to detect specific objects and trigger alerts only when these objects are detected. For example, a metal detector triggers an alarm on detecting any metal object on the body of the person being scanned. Thus, there is a need for an improved system which detects specific concealed objects and reduces false alarm. The invention described herein addresses the above-described needs.

### SUMMARY

In one aspect of the invention, a system for scanning and detecting specific concealed objects using a radar system is disclosed. The system includes a radar-based sensor unit, a processing unit, a database and a communicator.

In another aspect of the invention, the radar-based sensor unit may include an array of transmitters and receivers which are configured to transmit a beam of electromagnetic radiations towards the person being scanned and receive the electromagnetic waves reflected from the person, respectively. The information received by the receiver may include a raw complex image which may be a 3D matrix of voxels. The sensor unit may also include a pre-processing unit which is configured to prepare convoluted slices from the raw complex image. The exemplary convoluted slices that may be used by the pre-processing unit may include one or more of a maximum intensity slice, a range slice, a Laplacian slice and a median value slice. The processing unit receives the convoluted slices from the pre-processing unit for detecting concealed objects using convolutional neural network.

In a further aspect of the invention, the processed data from the processing unit along with the raw complex image collected by the receiver and the convoluted slices produced by the pre-processing unit are stored in the database. On the detection of the specific concealed objects, the communicator may transmit a notification to the concerned parties through a communication network.

As appropriate, an anomaly detector may be used to detect deviations from a standard body. Detected deviations may be indicative of possible detections of non-specific concealed objects.

As appropriate, the data stored in the database may be used to train the processing unit for accurately detecting the specific concealed objects thereby reducing false alarms.

In a further aspect of the invention, a method is taught for scanning a target subject and detecting concealed objects. Where required, the method may further include detecting at least one of a position of the concealed object within the target subject, a size of the concealed object, and a shape of the concealed object.

Variously, the method may comprise transmitting, by an array of transmitters, a beam of electromagnetic radiations towards the target subject and receiving, by an array of receivers, a beam of electromagnetic radiations reflected from the target subject, wherein the received electromagnetic radiations comprise a raw complex image. The method further comprises receiving, by a pre-processing unit, the raw complex image from the receivers and generating a plurality of convoluted slices and processing, by a processing unit, the convoluted slices for detecting the concealed object within the target subject. Optionally a complex convolution neural network is used to process complex convoluted slices to generate an output feature map matrix.

In particular examples of the method, the convoluted slices each comprise an array of complex slice values and a complex convolution neural network is used to process the complex convoluted slices for detecting the concealed object within the target subject. Optionally, the complex convolution neural network is used by providing a complex kernel comprising an array of complex mask values; applying complex functions to the complex mask values and the complex slice values; and generating a complex output feature map.

Where the complex image data comprises a phase space complex image data matrix M including a real component M_{R} and an imaginary complex component M_{I}, the output feature map matrix M′ may be generated by applying a complex kernel matrix K including a real component K_{R} and an imaginary complex component K_{I} such that

$${M}^{′} = M * K = ( {M}_{R} + i {M}_{I} ) * ( {K}_{R} + i {K}_{I} ) = ( {M}_{R} * {K}_{R} - {M}_{I} * {K}_{I} ) + i ( {M}_{R} * {K}_{I} + {M}_{I} * {K}_{R} ) .$$

Furthermore, complex pooling may be used to generate a reduced array by selecting a representative complex element for each sub region array. For example, the complex pooling may involve selecting an element (ak+ibk) from a sub region array having the highest absolute value √(ak2+bk2). Additionally or alternatively, the complex pooling may include calculating an arithmetic mean value

$$( \frac{Σ {a}_{k}}{N} + i \frac{Σ {b}_{k}}{N} )$$

for a sub region array of N elements (ak+ibk) by summing the elements and dividing by the number of elements in the sub region array. Still further, complex pooling may involve other methods such as striding, selecting a median, selecting a geometric mean, selecting a weighted average and the like as well as combinations thereof.

Where appropriate, complex activation functions may be used in an activation layer of the complex convolution neural network. For example, the complex activation function comprises setting the value to zero if both the real and imaginary parts are negative: Relu(a+bi)=a+bi if a>0 or b>0 else 0. Additionally or alternatively, the complex activation function comprises setting the value to zero if the magnitude is below than a minimum threshold value (such as 0.1) Relu(a+bi)=a+bi if a²+b²>0.1 else 0. Still additionally or alternatively, the complex activation function comprises setting the value to zero if both the real and imaginary parts are negative or if the magnitude is below than a minimum threshold value: Relu(a+bi)=a+bi if (a>0 or b>0) and a²+b²=0.1 else 0. In particular examples, the complex activation function comprises applying the function: Relu(a+bi)=(1/2)·(1+cos ϕ)·a+(1/2)·(1+cos ϕ)·bi, where 0=arctan(b/a).

As appropriate, the method further comprises storing, in a database, one or more of the raw complex images received by the receiver, the convoluted slices generated by the pre-processing unit and an identification of the detected concealed object.

As appropriate, the method further comprises training the processing unit for detecting the concealed objects using the information stored in the database. Optionally, the training of the processing unit for detecting the concealed objects is done using a Machine Learning (ML) algorithm.

As appropriate, the method further comprises transmitting, by a communicator, a notification of the detected concealed object to one or more concerned authorities through a communication network.

As appropriate, the method further comprises detecting, by an anomaly detector, deviation of the detected concealed object from a standard identification stored in the database. For example, the detected deviation may be indicative of detection of non-specific concealed objects.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings in which:

FIG. 1 illustrates a schematic representation of a radar-based system 100 for scanning a subject and detecting specific concealed objects according to an aspect of the invention;

FIG. 2 illustrates a schematic representation of an exemplary scanning arrangement using a handheld scanner according to an aspect of the invention;

FIG. 3 illustrates a schematic representation of an exemplary scanning arrangement using a mounted full body scanner according to an aspect of the invention;

FIG. 4A is a schematic representation of a subject passing through an exemplary walk-through full body scanner according to an aspect of the invention;

FIG. 4B is a schematic representation of a top view of the exemplary walk-through full body scanner according to an aspect of the invention;

FIGS. 4C and 4D illustrate possible alternative full body scanners;

FIGS. 5A-5D are various alternative walkthrough scanners;

FIG. 6A indicates a set of four adjacent frames arranged in a two by two array;

FIG. 6B is a flowchart illustrating steps of a scanning cycle of multiple frames of a walkthrough scanner;

FIGS. 7A-7D schematically illustrate scanning cycle of an array including multiple frames;

FIG. 8 illustrates a flowchart showing method steps for scanning and detecting specific concealed objects using a radar system according to an aspect of the invention;

FIG. 9A illustrates a 2D graphical representation of pre-processing the raw complex image using Maximum Intensity convoluted slices;

FIG. 9B illustrates a 2D graphical representation of pre-processing the raw complex image using Range convoluted slices;

FIG. 9C illustrates a 2D graphical representation of pre-processing the raw complex image using Laplacian convoluted slices;

FIG. 9D illustrates a 2D graphical representation of pre-processing the raw complex image using Median value convoluted slices;

FIGS. 10A and 10B illustrate 2D graphical representations of pre-processing the raw complex image using Median value convoluted slices;

FIG. 11 shows a set of 24 two dimensional slices representing intensity at different depths generated from a three dimensional 81×81×24 array of complex values;

FIG. 12A is an example of a slice to which a median filter has been applied;

FIG. 12B shows the results of a CNN trained using median filter slices;

FIG. 13A is an example of a slice representing three separate input channels;

FIG. 13B shows the results of a CNN trained using three separate input channels;

FIG. 14A is an example of nine selected real value intensity slices selected with the highest SNR;

FIG. 14B shows the results of a CNN trained using nine selected real value intensity slices selected with the highest SNR;

FIG. 15A shows the architecture of a possible CNN for processing real value image inputs;

FIG. 15B shows the architecture of a possible complex CNN for processing complex value image inputs;

FIG. 16A is an example of nine selected intensity slices, nine selected phase slices, nine selected real value slices representing complex value slices with the highest SNR; and

FIG. 16B shows the results of a CNN trained using nine selected complex value slices selected with the highest SNR.

### DETAILED DESCRIPTION

Aspects of the invention relate to systems and methods for detecting concealed objects using a radar system. In one aspect the invention relates to the use of a radar system which is trained to identify specific objects using machine learning. The transmission and reception of electromagnetic signals from the person being scanned produces a raw complex image. The raw complex image is processed to identify those specific concealed objects and trigger alarm.

Further aspects of the invention relate to systems and methods for radar imaging of concealed surfaces. Radar based walk-through security scanners are provided which have scan times sufficiently fast to capture images of subjects passing therethrough in real time.

As required, the detailed embodiments of the invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the invention.

As appropriate, in various embodiments of the invention, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard disk, flash-drive, removable media or the like, for storing instructions and/or data.

It is particularly noted that the systems and methods of the invention herein may not be limited in its application to the details of construction and the arrangement of the components or methods set forth in the description or illustrated in the drawings and examples. The systems and methods of the invention may be capable of other embodiments, or of being practiced and carried out in various ways and technologies.

Alternative methods and materials similar or equivalent to those described herein may be used in the practice or testing of embodiments of the invention. Nevertheless, particular methods and materials described herein for illustrative purposes only. The materials, methods, and examples not intended to be necessarily limiting. Accordingly, various embodiments may omit, substitute, or add various procedures or components as appropriate. For instance, the methods may be performed in an order different from described, and that various steps may be added, omitted or combined. In addition, aspects and components described with respect to certain embodiments may be combined in various other embodiments.

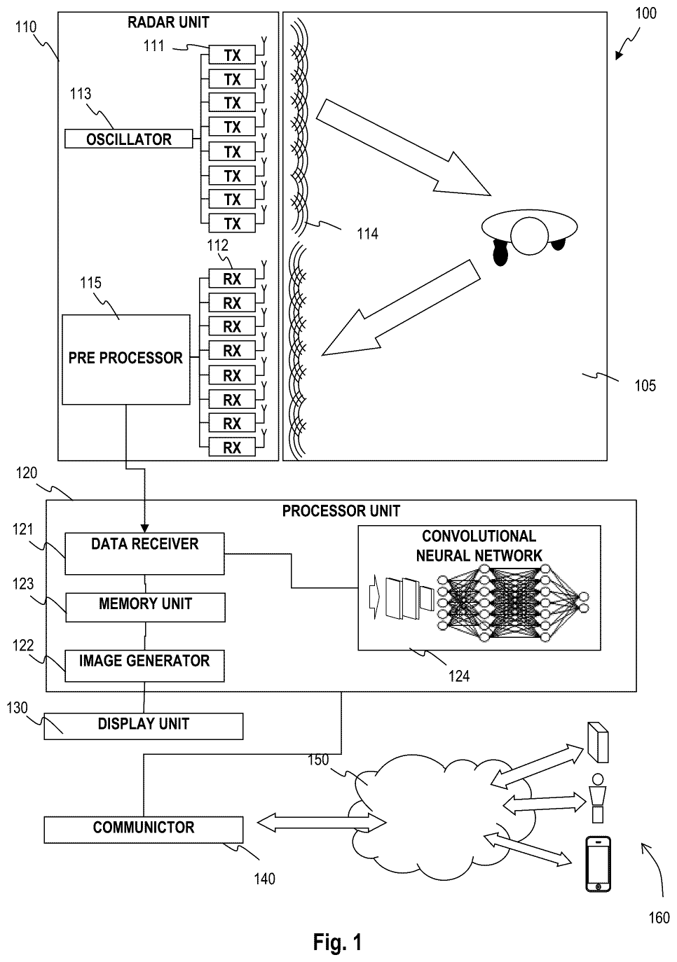

Reference is now made to FIG. 1, which is a schematic representation of a radar-based system 100 for scanning a subject and detecting specific concealed objects according to an aspect of the invention. The system 100 includes a radar unit 110, a processor 120, a display unit 130 and a communicator 140. The radar unit 110 includes at least one transmitter antenna 111 and at least one receiver antenna 112, an oscillator 113 and optionally a pre-processor 115. The transmitter 111 is connected to the oscillator 113 and configured to transmit electromagnetic radiation 114 into a target region 105. The receiver 112 is configured to receive electromagnetic waves reflected by objects within the target region 105 and is operable to generate raw data which may be processed by the preprocessor 115 where required.

The raw data generated by the receivers 112 is typically a set of magnitude and phase measurements corresponding to the waves scattered back from the objects in front of the array. Spatial reconstruction processing is applied to the measurements to reconstruct the amplitude (scattering strength) at the three-dimensional coordinates of interest within the target region. Thus, each three-dimensional section of the volume within the target region may represented by a voxel defined by four values corresponding to an x-coordinate, a y-coordinate, a z-coordinate, and a complex amplitude value a+ib having a real part a and an imaginary part b which can represent a magnitude of reflected energy z=√(a²+b²), and the phase

$$ϕ = arctan ( \frac{b}{a} )$$

of the signal reflected from the corresponding point.

The processor unit 120 includes a complex data receiver 121, a memory unit 123 and a convolutional neural network 124. Where required, the processor unit 120 may further include an image generator and a display unit 130.

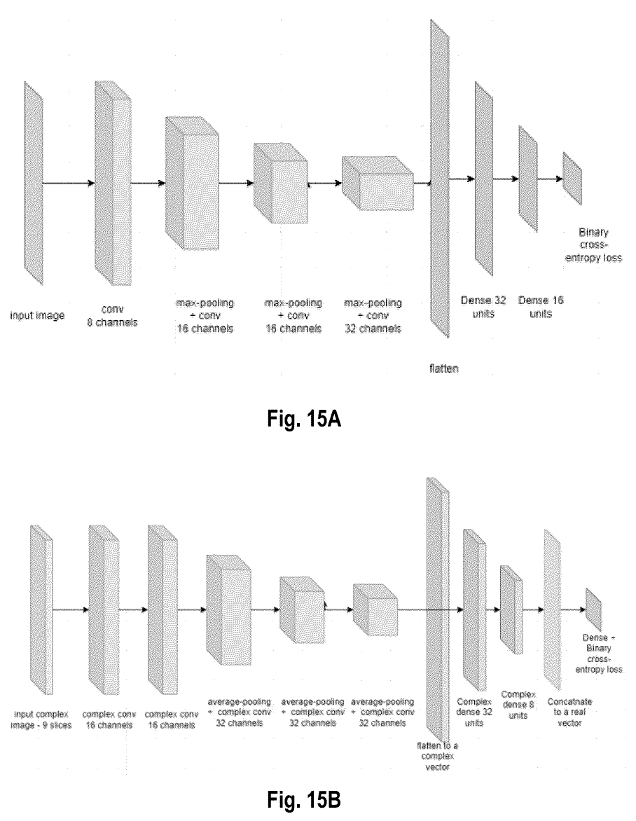

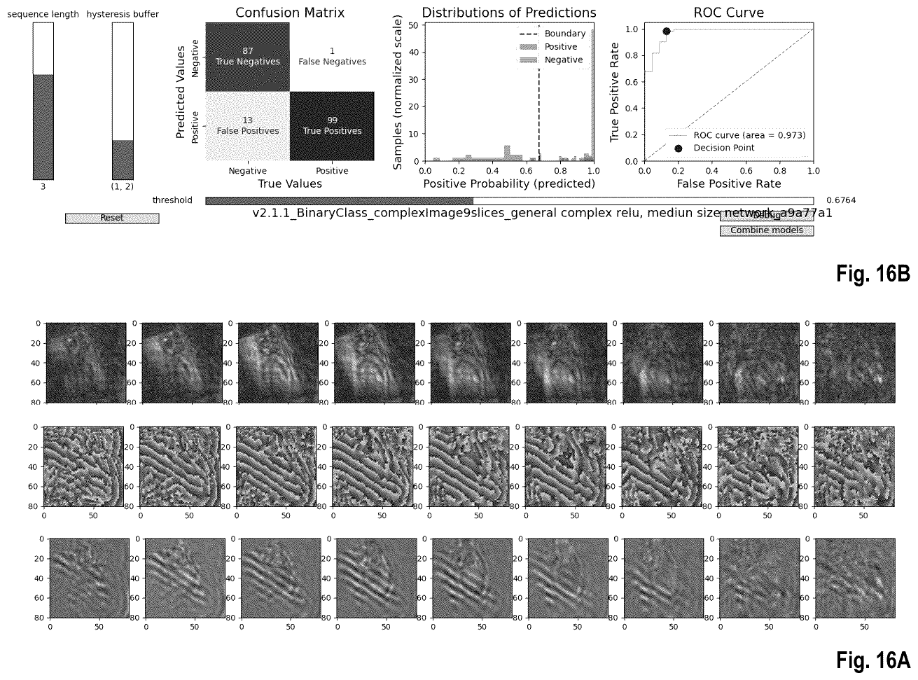

The complex data receiver 121 is configured to receive complex data from the radar unit 110 and may be operable to execute an image data generation function to generate image data based upon the received data. A memory unit 123 is provided to store the image data thus generated. The processor unit 120 may further be operable to transfer complex image data to the convolutional neural network 124. The Convolutional neural network is a machine learning deep neural network trained to receive the complex data detect specific objects as suit requirements. FIGS. 15A and 15B show possible layer structures for the layers of embodiments the convolutional neural network for analyzing real value input arrays and complex value input arrays respectively.

Where appropriate, an image generator 122 may be provided to convert the image data into a displayable image. Accordingly, a display unit 130 may be configured and operable to present an array of pixels displaying an image representing targets within the target region, such as concealed surfaces under the clothing of a passing subject for example.

The system 100 may be used within a production line of a factory establishment manufacturing objects, like watches, mobile phones, precious jewelry or gems, small vehicle parts, etc. The system 100 may alternatively be used within a warehouse storing objects which has the danger of theft and can easily be concealed within a person's body or clothing. The system 100 may further be used for security purpose at airports, shopping malls and other public places for detecting concealed weapons or bombs. The above-mentioned exemplary usage of the system 100 should not limit the scope of the invention.

The radar 110 typically includes at least one array of radio frequency transmitter antennas 111 and at least one array of radio frequency receiver antennas 112. The radio frequency transmitter antennas 111 are connected to an oscillator 113 (radio frequency signal source) and are configured and operable to transmit electromagnetic waves 114 towards the target region. The radio frequency receiver antennas 112 are configured to receive electromagnetic waves 114 reflected back from objects within the target region.

Accordingly, the transmitter 111 may be configured to produce a beam of electromagnetic radiation 114, such as microwave radiation or the like, directed towards a monitored region such as an enclosed room or the like. The receiver may include at least one receiving antenna or array of receiver antennas 112 configured and operable to receive electromagnetic waves reflected by objects within the monitored region.

In order for concealed objects to be rendered visible by a radar, the frequency of transmitted radiation is selected, in one embodiment of the invention, such that concealing layers are transparent to the transmitted radiation and the reflected radiation which pass therethrough.

The communication module 140 is configured and operable to communicate information to third parties 160. Optionally the communication module 140 may be in communication with a computer network such as the internet 150 via which it may communicate alerts to third parties, for example via telephones, computers, wearable devices or the like 160.

The system 100 is trained to detect specific objects within the environment in which it is being used and trigger the alert only on the detection of these objects. For example, the system 100 used in a production line manufacturing watches is trained to detect and raise alert only for the concealed watches and not for other objects. Similarly, the system 100 being used in a jewelry manufacturing unit is configured to detect only jewelry items.

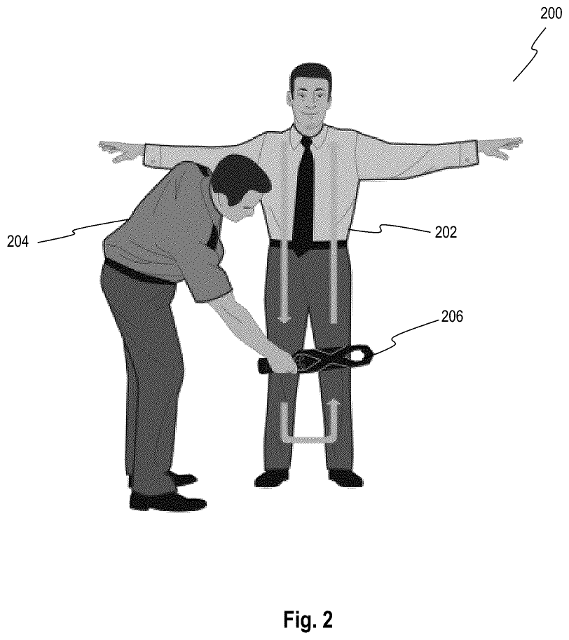

The radar-based sensor unit 104 may be a portable hand device 206 as shown in FIG. 2 which illustrates a schematic representation of an exemplary scanning arrangement 200 using the handheld scanner 206 according to an aspect of the invention. The scanner 206 is used to scan a person 202 by a security official 204 by moving the scanner 206 over the entire body of the person 202. The radar-based scanner 206 transmits electromagnetic signals towards the whole body of the person 202.

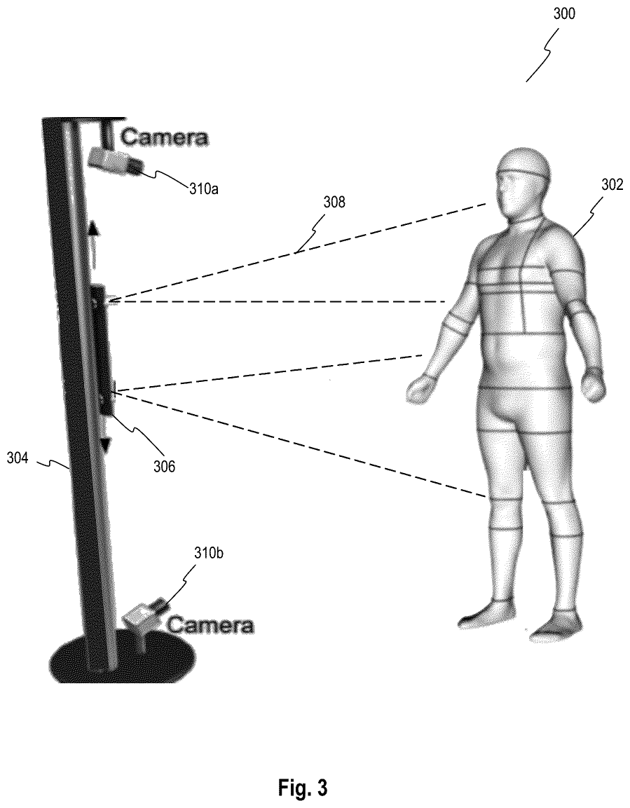

In an alternative embodiment, the radar-based sensor unit 104 may be a mounted full body scanner 306 mounted on a pole 304 as illustrated in FIG. 3. The scanner 306 transmits electromagnetic signals 308 towards a person 302 being scanned. The scanning arrangement 300 may also include cameras 310a and 310b mounted on the pole 304 for capturing an image of the person 302.

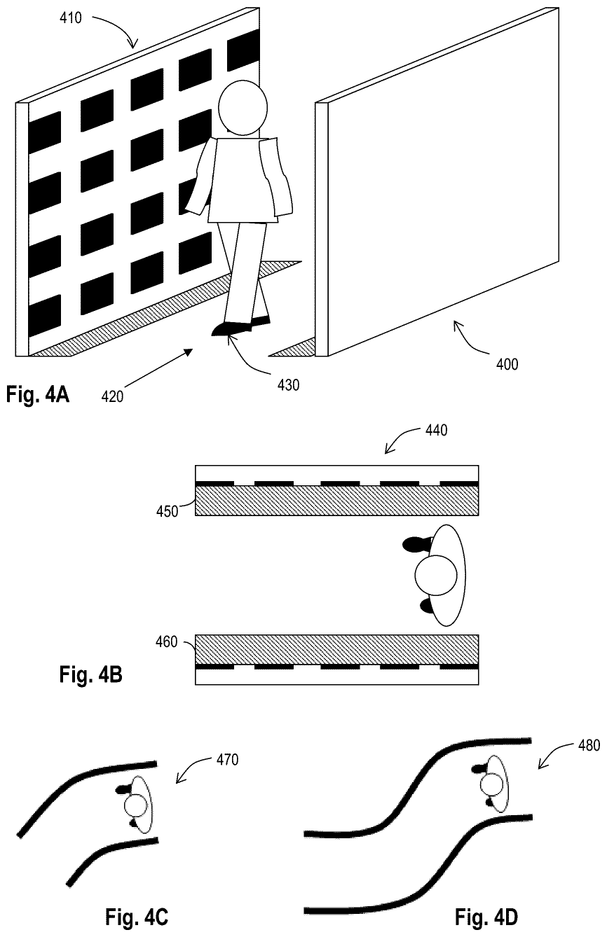

In a yet another alternative embodiment, the radar-based sensor unit 104 may be walk-through full body scanner as illustrated in FIGS. 4A and 4B which schematically represent respectively an isometric view 400 and a top view 440 of a subject 430 passing through an example of a walk-through full body scanner.

The full body scanner of the example includes a scanning arrangement 410 and a corridor 420 through which the subject 430 may pass.

The scanning arrangement includes a first array of transceivers 450 and a second array 460 facing the first array. The corridor 420 through the scanning arrangement provides an unobstructed path between the facing arrays of the scanning arrangement.

As the subject 430 passes along the unobstructed path, radiation emitted by transmitters 450 and 460 of the scanning arrangement is reflected from the subject 430 to be detected by receivers. Variously, the scanning radiation may be emitted by a transmitter of the first array 450 and reflected by the subject back towards receivers of the first array. Similarly, the scanning radiation may be emitted by a transmitter of the second array 460 and reflected by the subject back towards receivers of the second array.

Alternatively, the scanning radiation may be emitted by a transmitter of one array and reflected by the subject towards receivers of the other array. Thus, the radiations received by the first array 450 may have been emitted by the first array or the second array. Similarly, the radiations received by the second array 460 may have been emitted by first array or the second array.

In order to provide a 360 degree all round scanning, the dimensions, such as length and width of the corridor 420 are chosen such that a subject 430 passing along the length of the corridor 420 will at some position along the path reflect scanning radiation towards a receiver from every part of its surface. Accordingly, as the subject 430 passes along the unobstructed path, for each surface-section of the subject 430, there is a position along the path at which scanning radiation transmitted from at least one transmitter of the scanning arrangement is reflected by that surface-section and received by at least one receiver of the scanning arrangement. Furthermore, where appropriate, it may be possible to achieve full 360 degree coverage in as small a number of frames as possible.

Although only two walls are indicated in the FIGS. 4A and 4B for illustrative purposes, where required, additional scanning arrays may be provided above and below the corridor to increase coverage range when necessary.

Referring now to FIGS. 4C and 4D, which illustrate alternative full body scanners 470 and 480, it is noted that other configurations of the walk-through scanner may have curved paths. A subject passing along the corridor of such scanning arrays naturally turns relative to the scanning arrangements within the walls and thus the scanning arrays may more readily image the subject from the sides, the front and the rear thereby providing 360 degree imaging.

In the scanning arrangements 200, 300 and 400 of FIGS. 2, 3 and 4, respectively, the scanners 206, 306 and 410 may comprise the radar-based sensor unit 110. The other components of the system 100 like the processor 120, the communicator 140 and the display unit 130 may be located at a remote central terminal or at remotely distributed terminals. In such a case, the scanners 206, 306 and 410 may transmit the preprocessed data to the remotely located processing unit 120 for detecting the concealed objects. In an alternative embodiment, the pre-processing unit 115 may also be a separate unit and located remotely from the scanners 206, 306 and 410. In a further alternative embodiment, all the components including the radar-based sensor unit 110, the processor 120, the communicator 140 and the display unit 130 may be located within the scanners 206, 306 and 410.

It has been found that in order to clearly image a moving subject using a radar scanning apparatus, the subject must not move significantly during each scanning cycle. Accordingly, where the radar scanner uses scanning radiation with millimeter scale wavelength, it is important that the subject moves less than about a millimeter during each scan cycle. Methods are described herein for providing scanning cycles with scan times or less than a few milliseconds suitable for imaging walking subjects.

Referring back to FIG. 1, the radar-based system 100 may be used, say, in a production line manufacturing wrist watches. Accordingly, the system 100 is trained to detect concealed watches using Machine Learning (ML) algorithms. The system 100 may employ any of the known ML algorithm as per the requirement. The algorithm can be a Supervised Learning algorithm which consists of a target/outcome variable (or dependent variable) which is to be predicted from a given set of predictors (independent variables). Exemplary Supervised Learning algorithms include Regression, Decision Tree, Random Forest, KNN, Logistic Regression etc. Alternatively, algorithm can be a Reinforcement Learning algorithm using which the machine is trained to make specific decisions. Exemplary Reinforcement Learning algorithm includes Markov Decision Process.

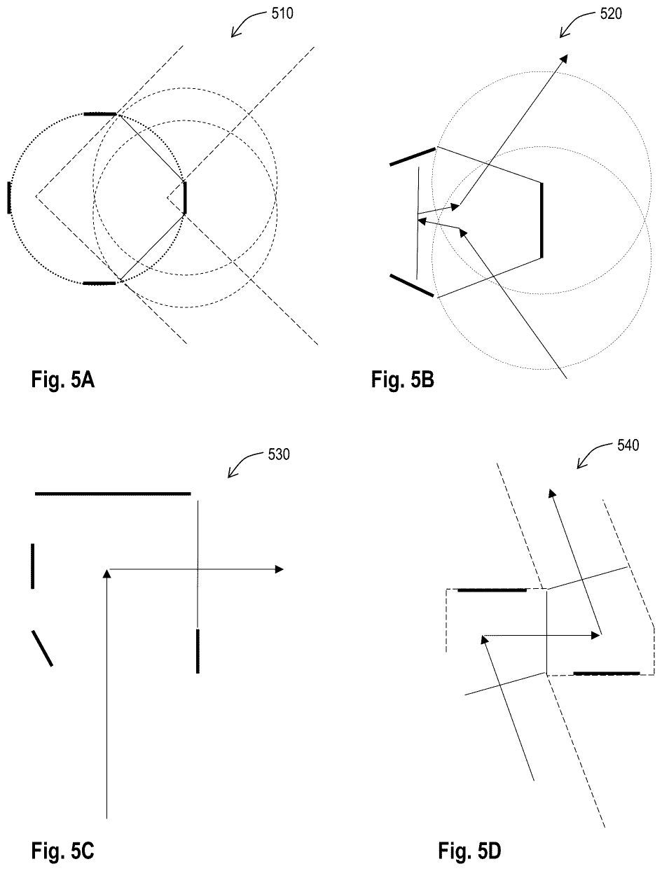

Referring now to FIGS. 5A-5D, various configurations for walkthrough scanners of the invention are indicated which may enable effective all round scanning of subjects passing along a path therethrough. It is noted that typical constraints for such configurations maybe that the corridor entering the scanning region may have an opening of approximately 75 centimeters or so and that subjects passing along the corridor should not have to rotate through angles greater than 90 degrees.

Accordingly, FIG. 5A indicates a first configuration 510 in which a corridor is provided leading the subject through a target region in which scanners are provided which has scanners around four sides of the subject as the subject turns: in front of the subject, behind the subject, to the right of the subject and to the left of the subject.

Other configurations will occur to those skilled in the art. For example, FIG. 5B indicates an alternative arrangement 520 in which only three scanning arrays are provided but the subject is required to make an about turn, FIG. 5C indicates another arrangement 530 requiring a 90 degree turn from the subject but having a different scanning configuration, FIG. 5D indicates, still a further arrangement 540 in which the subject is required to make two turns through a kind of chicane corridor which serves both to provide walls upon which to mount the scanners and also to slow the subject passing through the scanner.

In one embodiment of the invention the radar scanning apparatus has a short enough scan time that a clear image may be provided of a subject passing through the target region. Accordingly, a method is taught for reducing the scan time in a multiframe scanner.

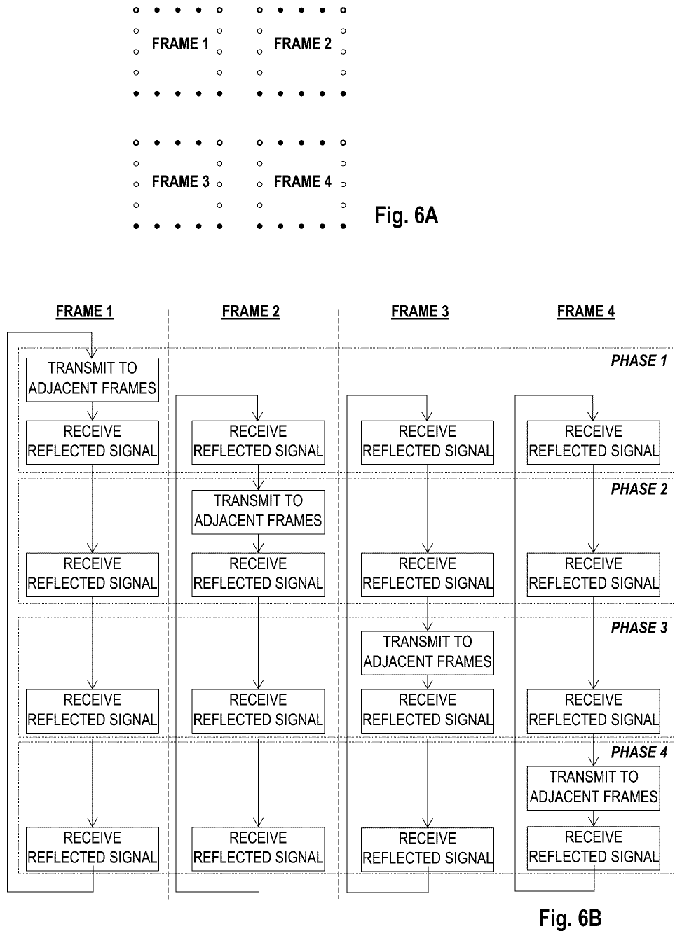

Referring now to FIG. 6A, which illustrates a quartet of four adjacent frames arranged in a two by two array and FIG. 6B which indicates a method of operation for each of the set of four frames.

Typically, in multiframe scanners, a scanning cycle involves each frame transmitting in turn to all other frames in the scanning array. Thus the total scan time is equal to the number of frames in the scanner array times the time required for each frame to transmit at each required transmission frequency. In order to reduce the scan time, frames of the scanning arrangement may be configured and operable to transmit in parallel. For example, parallel transmission may be enabled by each transmitter transmitting in parallel at a distinct frequency, with a distinctive modulation, with a distinctive duty cycle or the like.

Accordingly, as indicated in FIG. 6A each frame in every quartet of the scanning arrangement is labeled such that the top left frame is labeled FRAME 1, the top right frame is labeled FRAME 2, the bottom left frame is labeled FRAME 3, and the bottom right frame is labeled FRAME 4. In this way, all frames labeled FRAME 1 are configured to transmit in parallel, all frames labeled FRAME 2 are configured to transmit in parallel, all frames labeled FRAME 3 are configured to transmit in parallel, and all frames labeled FRAME 4 are configured to transmit in parallel.

With reference to the flowchart of FIG. 6B the steps of a four phase scanning cycle are presented for reducing the scan time for the multiple frames of a walkthrough scanner. During the first phase only FRAME 1 of each quartet transmits and all the frames receive the reflected signal. During the second phase only FRAME 2 of each quartet transmits and all the frames receive the reflected signal. During the third phase only FRAME 3 of each quartet transmits and all the frames receive the reflected signal. During the fourth phase only FRAME 4 of each quartet transmits and all the frames receive the reflected signal. The cycle then returns to the first phase, and this is repeated.

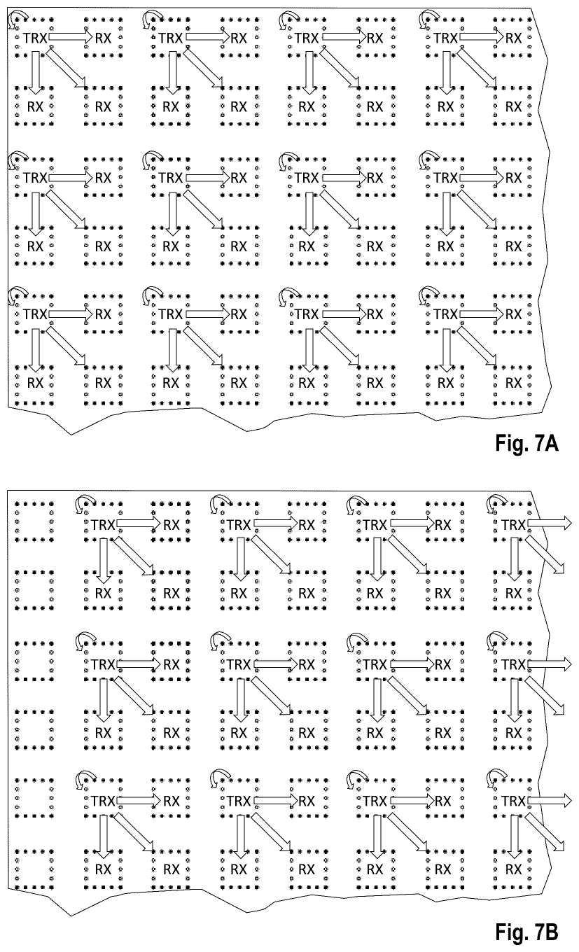

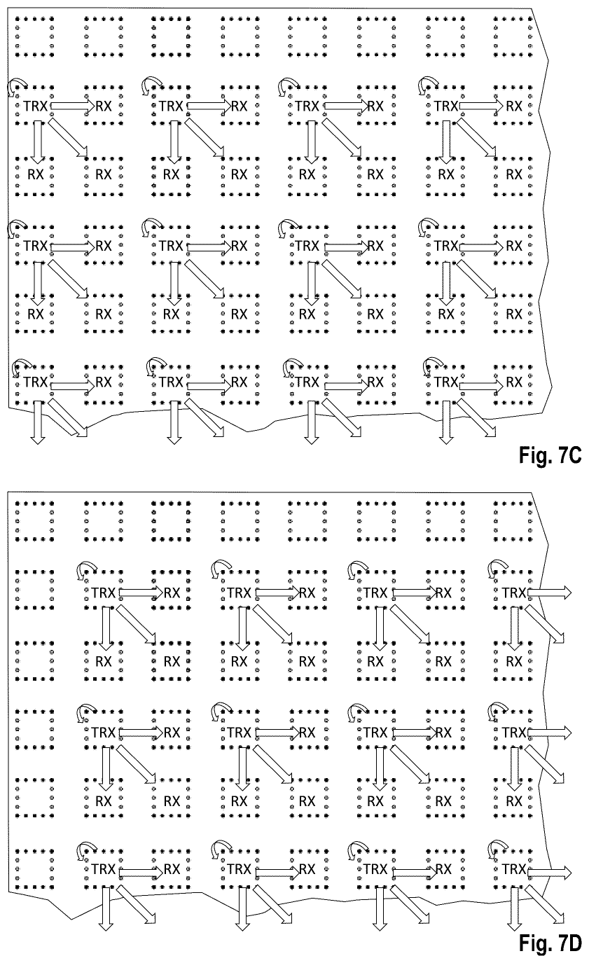

Referring now to FIGS. 7A-7D, the scanning cycle across the multiple frame array has a greatly reduced scan time because each frame only transmits to its immediate neighbors. FIG. 7A illustrates the transmission status during Phase 1 of the cycle during which all the FRAME 1 transceivers transmit to themselves and their immediate neighbors. Similarly FIG. 7B illustrates the transmission status during Phase 2 of the cycle during which all the FRAME 2 transceivers transmit to themselves and their immediate neighbors. Likewise FIG. 7C illustrates the transmission status during Phase 3 of the cycle during which all the FRAME 3 transceivers transmit to themselves and their immediate neighbors. Finally, FIG. 7D illustrates the transmission status during Phase 4 of the cycle during which all the FRAME 4 transceivers transmit to themselves and its immediate neighbors.

Referring back to FIG. 1, in an aspect of the invention, the system 100 is used for imageless scanning and detecting concealed objects using the radar system 110. The receiver 112 may include an array of receiver antennas configured and operable to receive electromagnetic waves reflected by objects within the target region 105. In one embodiment, the information received by the receiver 112 may include a raw complex image data which may be a 3D matrix of voxels (say 181×181×24).

The raw complex image data received by the receiver 112 may be sent to the pre-processing unit 115 of the radar-based sensor unit 110. The raw image may be processed to detect concealed objects using a variety of methods.

By way of example, in some embodiments, the pre-processing unit 115 may be configured to prepare convoluted slices (say 181×181) from the raw complex image. The various exemplary convoluted slices may include for example, a maximum intensity slice, a Range slice, a Laplacian slice, a median value slice or the like.

The maximum intensity slice may be a matrix of the energy levels of the voxels with the highest intensity for each pair of orthogonal coordinates. The Range slice may be a matrix of the argument values of the voxels with the highest energy values for each pair of orthogonal coordinates. The Laplacian slice may be a matrix of phase values of the z-plane containing the voxel having the highest intensity. The median value slice may be a matrix of average energy values for each voxel.

Accordingly, the Raw Complex Image of size 181×181×24 is reduced during preprocessing to a preprocessed image of size 181×181×5 using the following slices:

Intensity = max(abs(I))
Range = argmax(abs(I))
Laplacian on the phase of the z-slice containing the max value
Median Intensity
Median Depth

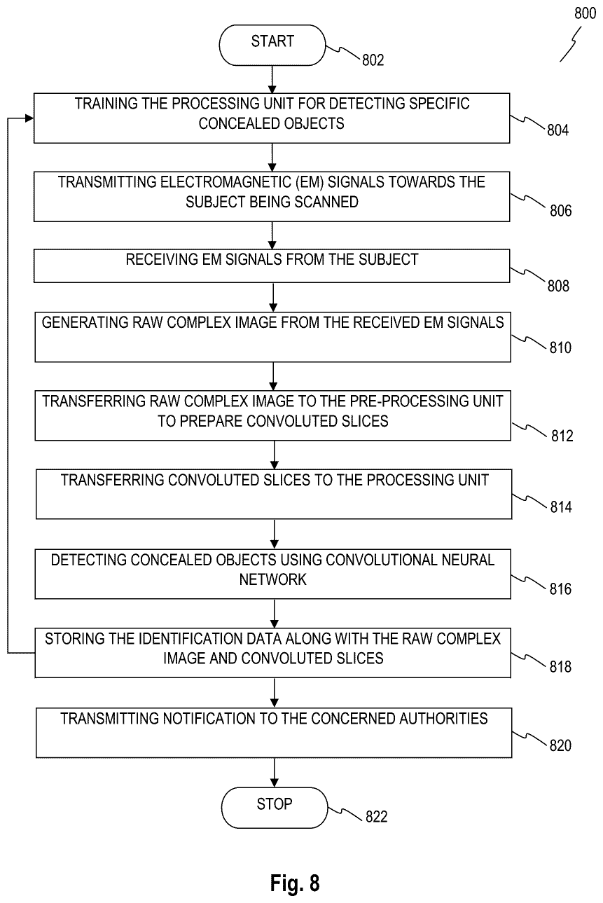

Referring to FIG. 8 which illustrates a flowchart 800 showing method steps for scanning and detecting specific concealed objects using the radar system 100 according to an aspect of the invention. The process starts at step 802 and the processing unit 120 is trained for detecting specific concealed objects at step 804. The processing unit 120 is trained to detect specific objects as per the environment in which the system 100 is being used. Accordingly, the processing unit 120 may be trained to detect concealed objects using Machine Learning (ML) algorithms. The processing unit 120 may employ any of the known ML algorithm as per the requirement.

At step 806, the EM signals from the transmitting antennas 111 of the radar unit 110 are transmitted to the subject being scanned in the target region 105. The signals reflected from the subject are received by the receiver antennas 112 at step 808 and are used to generate a raw complex image which may be a 3D matrix of voxels (say 181×181×24) at step 810. At step 812, the raw complex image is sent to the pre-processing unit 115 of the radar-based sensor unit 110. The pre-processing unit 115 is configured to prepare convoluted slices (say 181×181) from the raw complex image. The exemplary convoluted slices that may be used by the pre-processing unit 115 may include one or more of a maximum intensity slice, a range slice, a Laplacian slice and a median value slice.

At step 814, the convoluted slices are sent to the processing unit 120 for detecting concealed objects using convolutional neural network at step 816. At step 818, the processed data from the processing unit 120 is stored in the database 123. The database 123 may also store the raw complex image collected by the receiver 112 and the convoluted slices produced by the pre-processing unit 115. All or some of these data may be used to train the processing unit 120 for detecting specific concealed objects. The detection of concealed objects may trigger an alarm or notification to alert the concerned authorities 160 at step 820. The notification may be provided in audio/visual form. The process completes at step 822.

The term “convoluted” throughout this specification means “an outcome of the convolution operation”, or an “an outcome of a layer within a convolutional neural network”.

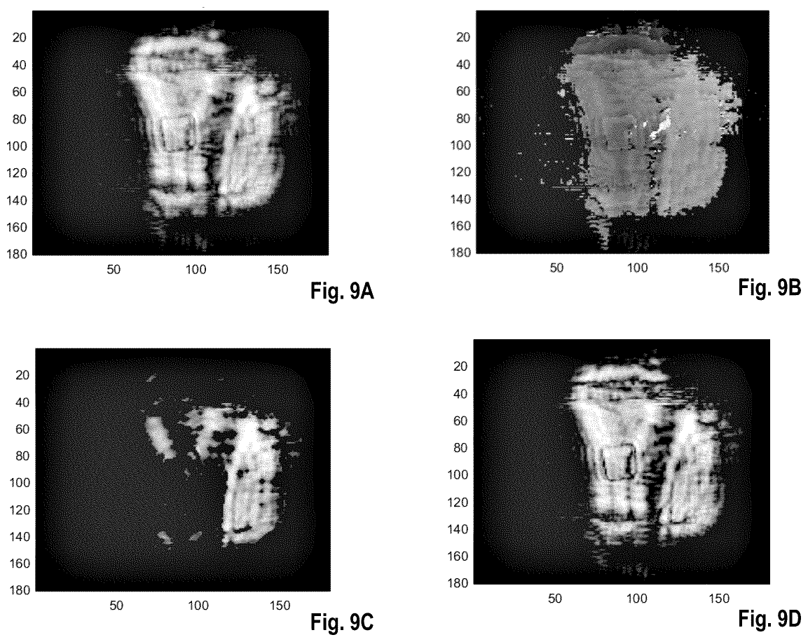

FIGS. 9A-9D illustrate two-dimensional (2D) graphical representations of pre-processing the raw complex image using Maximum Intensity convoluted slices (FIG. 9A), Range convoluted slices (FIG. 9B), Laplacian convoluted slices (FIG. 9C), and Median value convoluted slices (FIG. 9D).

By way of illustration only, in some embodiments, the raw complex image may be preprocessed using median value convoluted slices as per the following algorithm:

Given 3dImage (181 × 181 × 24) − I
Calculate Raw_Depth = argmax(I) in z dimension.
Median_Depth = median(Raw_depth) on X and Y coordinates, filter
kernel size 15.
Calculate Median_Intensity = I(z = Median_Depth)
Processing is performed on Median_Intensity

It will be appreciated that other preprocessing may be used as suit requirements. For example, in some examples the image may be cropped to remove borders or spacers.

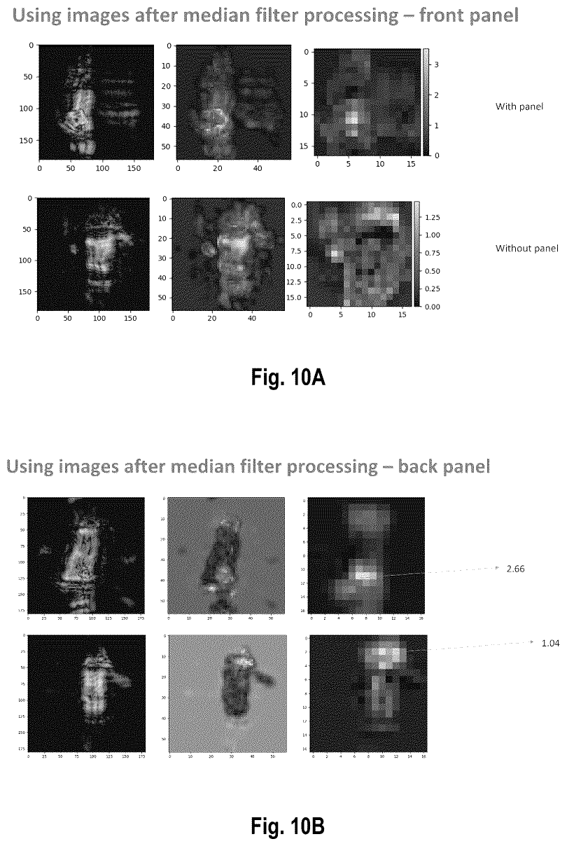

FIGS. 10A and 10B illustrate 2D graphical representations of pre-processing the raw complex image using median value filtering process.

The convoluted slices produced by the pre-processing unit 115 are sent to the processing unit 120 which is configured to analyze the slices and detect the concealed objects using a Convolutional neural network 124. The Convolutional neural network 124 is a machine learning deep neural network which is configured to detect specific objects as per the environment in which the system 100 is being used.

Raw image data generated by the radar comprises three dimensional arrays of voxels having complex amplitude values a+ib having a real part a and an imaginary part b which can represent a magnitude of reflected energy z=√(a²+b²), and the phase ϕ=arctan

$$( \frac{b}{a} )$$

of the signal reflected from the corresponding point, Nevertheless traditional convolutional neural networks which are only configured to analyze real values require the reduction of the complex amplitude values of the input image into real values.

In one aspect of the invention a CNN is trained more efficiently to analyze complex image inputs such that both energy and phase data are utilized to improve detection and identification of specific concealed objects. In some embodiments the preprocessor 115 may collapse the complex raw image into real value array representations for example a median filter may be applied to the three dimensional complex image.

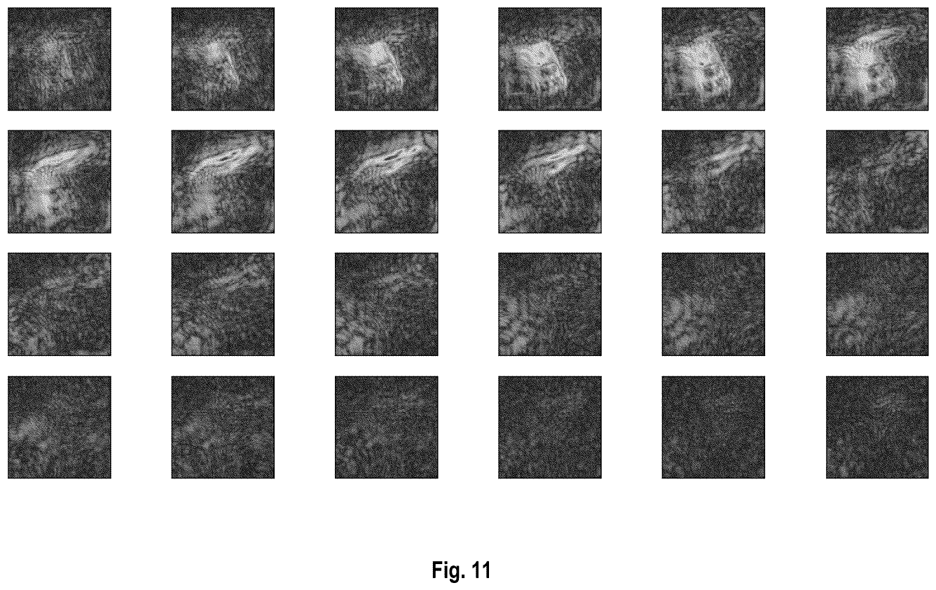

For example a three dimensional 81×81×24 array of complex values (an+ibn) may be collapsed by taking the magnitude √(an2+bn2) of each complex value into 24 two dimensional slices representing intensity at different depths, such as shown in FIG. 11.

Various methods for preprocessing inputs of a CNN have been considered for analyzing this data.

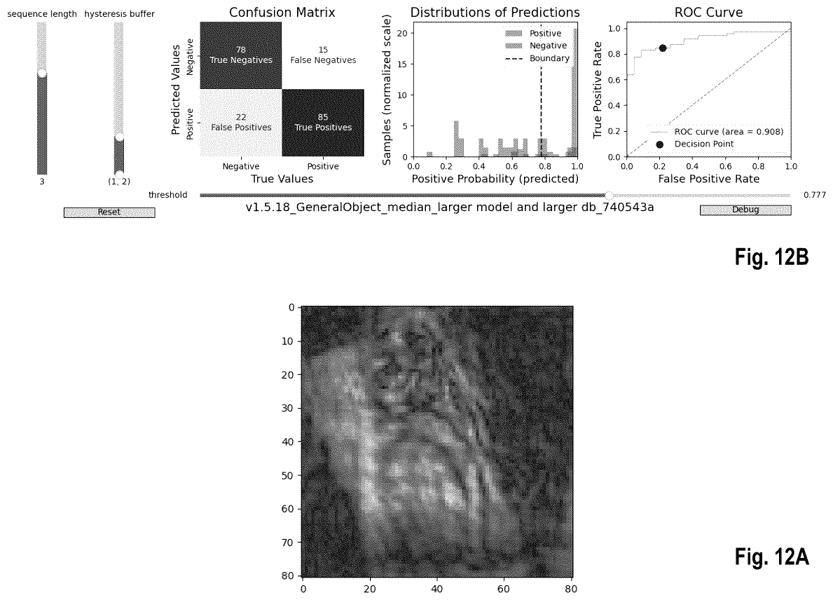

In a first method of analysis a CNN was trained on data in which a median filter was applied to a three dimensional image to remove low SNR voxels from these slices produces as shown in FIG. 12A. FIG. 12B shows the results of the CNN trained on median filtered images, which correctly identified concealed objects in 85% of cases and produced false positives in 22% of cases where no object is present.

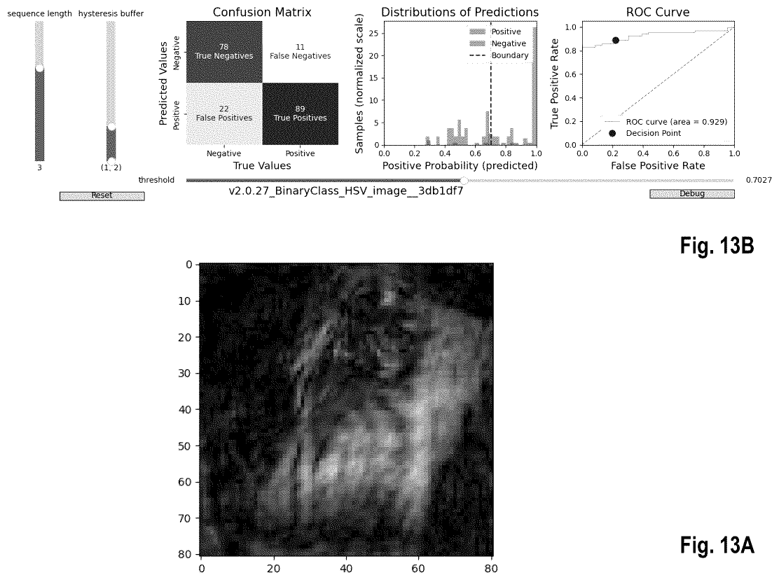

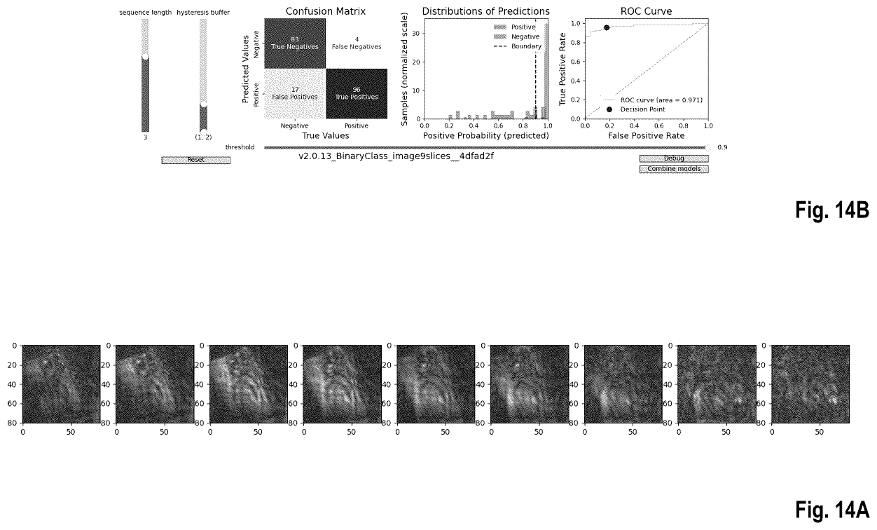

In a second method of analysis a CNN was trained on data in which three separate input channels were created as shown in FIG. 13A. A first channel for the median filter data slices, a second channel for slices to which a coherence factor was applied, and a third channel for slices representing unwrapped phase data. FIG. 13B shows the results of the CNN trained on these three channels, which correctly identified concealed objects in 89% of cases and again produced false positives in 22% of cases where no object is present.

In a third method of analysis a CNN was trained on data in from nine selected real value intensity slices with the highest SNR as shown in FIG. 14A. FIG. 14B shows the results of the CNN trained on the high SNR slices, which correctly identified concealed objects in 96% of cases and produced false positives in 17% of cases where no object is present.

The examples such as described above the preprocessor 115 is used to collapse the complex raw image into real value array which are analyzed by a CNN such as shown in FIG. 15A which uses real value kernels and functions in order to process the real value input image using an 8 channel convolution layer, two 16 channel max-pooling and convolution layers, and a further 32 channel max-pooling and convolution layer. The resulting flattened real value data vector is classified using a 32 unit dense layer and a 16 unit dense layer.

In another method of analysis a complex value input array is provided and a complex convolution neural network, such as shown in FIG. 15B, is using complex number functions to process the complex values of the array directly, thereby preserving both the energy data and the phase data.

The complex CNN uses complex value kernels and functions to perform complex convolution on complex image data comprising multiple slices of data each represented by an array of complex values, using two 16 channel complex convolution layer and three average-pooling complex convolution 32 channel layers. The resulting flattened complex data vector is classified using a 32 unit complex dense layer and then by a 16 unit complex dense layer before being concatenated into real vector and finally passed to a dense layer.

Using this method, the complex CNN was trained on data in from nine complex value slices with the highest SNR as shown in FIG. 16A which represents the complex value slices as nine intensity slices, nine phase slices, nine real value slices. FIG. 16B shows the results of the CNN trained on the high SNR slices, which correctly identified concealed objects in 99% of cases and produced false positives in 13% of cases where no object is present.

In one embodiment the invention introduces a complex convolution neural network such as shown in FIG. 15B which is configured to use complex functions to process complex values in all the various functional layers of the network such as pooling layers, convolution layers, activation layers and dense layers.

In particular, regarding the complex convolution layer, it has been found that a complex convolutional neural network which is able to process amplitude and phase content may stabilize training and improve results. Complex convolutional networks allow the phase space of radar image data to be explicitly modelled as convolutions of both the real component M_{R} and the complex component M_{I} of the complex image data matrix M as well as both the real component K_{R} and the complex component K_{I} of the complex kernel matrix K.

Accordingly, the complex convolution may be determined by generating a new matrix M′:

$${M}^{′} = M * K = ( {M}_{R} + i {M}_{I} ) * ( {K}_{R} + i {K}_{I} ) = ( {M}_{R} * {K}_{R} - {M}_{I} * {K}_{I} ) + i ( {M}_{R} * {K}_{I} + {M}_{I} * {K}_{R} )$$

Thus, a complex output feature map matrix may be generated by applying a complex mask to the complex values of an input feature map which retains the useful magnitude and phase information of the raw data with minimal loss.

Regarding pooling layers, a single value is generally selected for each region of the original array covered by a filter mask. When Max-pooling for a real array, the selected value is typically the element within the region of the feature map which has the highest value. Accordingly, Max-pooling generates a reduced array which has a smaller size, but which retains the data of the most prominent features of the original array.

It will be appreciated that max-pooling depends upon values having comparable sizes so that the maximum size can be selected. This may work well for arrays of real values because real values fall neatly along a one dimensional number line. However complex values lie on the two-dimensional complex plane and their sizes are therefore not trivial to compare. Accordingly, max-pooling is not appropriate for arrays of complex values.

It is a feature of the complex pooling in one embodiment of the invention that more sophisticated methods of comparing values and selecting elements in the arrays of complex values are introduced. For example: max-pooling may be mimicked for an array of complex values (ak+ibk) may be selected which has the highest absolute value √(ak2+bk2).

In another possible method, average-pooling may be used in which the complex values (ak+ibk) of N elements in the sub region are summed and the sum is divided by the number of elements in order to calculate the arithmetic mean value

$$( \frac{Σ {a}_{k}}{N} + i \frac{Σ {b}_{k}}{N} )$$

which is used as the equivalent element in the reduced array.

Other complex pooling layers may be used as suit requirements such as striding, selecting a median, selecting a geometric mean, selecting a weighted average or the like, for example.

Regarding the activation layer, activation functions used for arrays of complex numbers are again less trivial than for the real value case. A Relu function such as Relu(x)=max(x,0) may be a useful rectified linear unit activation function for real values. However it has been found that a similarly simple function for complex values, such as Relu(a+bi)=max(a,0)+max(b,0)i does not work as well.

Various possible rectified linear activation functions may be defined to act on complex values. Examples that have been tried include:
setting the value to zero if both the real and imaginary parts are negative:

$$Relu ( a + b i ) = a + bi if a > 0 or b > 0 else 0$$

setting the value to zero if the magnitude is below than a minimum threshold value (such as 0.1)

$$Relu ( a + b i ) = a + bi if {a}^{2} + {b}^{2} > 0.1 else 0$$

setting the value to zero if both the real and imaginary parts are negative or if the magnitude is below than a minimum threshold value:

$$Relu ( a + b i ) = a + bi if ( a > 0 or b > 0 ) and {a}^{2} + {b}^{2} = 0.1 else 0$$

All these possible functions and others may be used to provide activation in complex convoluted neural networks. However a particular function was found to be surprisingly successful during tests: Relu(a+bi)=(1/2)·(1+cos ϕ)·a+(1/2)·(1+cos ϕ)·bi, where ϕ=arctan(b/a).

In an exemplary embodiment, the processing unit 120 is trained to detect wrist watches concealed in clothes or body of a person in the target region 105. The processing unit 120 is further configured to detect the position of the concealed objects. For example, the processing unit 120 is configured to detect the wrist-watch tied on the hand of the person and hidden inside the sleeves of the shirt. Similarly, in a jewelry manufacturing unit, the processing unit 120 is configured to detect a gemstone hidden in the shoes of a person.

The processed data from the processing unit 120 is stored in the database 123. The database 123 may also store the raw complex image collected by the receiver 112 and the convoluted slices produced by the pre-processing unit 115. All or some of these data may be used to train the processing unit 120 for detecting the concealed objects.

As and when required, the detection of concealed objects may trigger an alarm or notification to alert the concerned authorities 160 via the communicator 140. The concerned authorities may include the security personal who is scanning the person. The notification may also be sent to a factory supervisor in case a concealed object is detected with the factory worker. The notification may also be sent to a nearby police station of the possible theft. The notification may further be sent on the mobile device of the warehouse owner. The notification may be provided in audio/visual form.

The notifications may be sent from the database 123 through the communicator 140 which transmits the information through a communication network 150. The communication network 150 may include Internet, a Bluetooth network, a Wired LAN, a Wireless LAN, a WiFi Network, a Zigbee Network, a Z-Wave Network or an Ethernet Network.

The systems and methods explained above may detect specific concealed objects in an efficient and accurate manner thereby reducing false alarms.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment. Certain features described in the context of various embodiments are not to be considered essential features of those embodiments, unless the embodiment is inoperative without those elements.

What is claimed is:

1. A method for scanning a target subject and detecting concealed objects, the method comprising:
transmitting, by an array of transmitters, a beam of electromagnetic radiations towards the target subject;
receiving, by an array of receivers, a beam of electromagnetic radiations reflected from the target subject, wherein the received electromagnetic radiations comprise a raw complex image;
receiving, by a pre-processing unit, the raw complex image from the receivers and generating a plurality of complex convoluted slices each comprising an array of complex slice values; and
using a complex convolution neural network to process the complex convoluted slices for detecting the concealed object within the target subject.

2. The method of claim 1 wherein the step of using a complex convolution neural network to process the complex convoluted slices comprises:
providing a complex kernel comprising an array of complex mask values;
applying complex functions to the complex mask values and the complex slice values; and
generating a complex output feature map.

3. The method of claim 2 further comprising using complex pooling to generate a reduced array by selecting a representative complex element for each sub region array.

4. The method of claim 3 wherein the complex pooling comprises selecting an element (aₖ+ibₖ) from a sub region array having the highest absolute value √(aₖ²+bₖ²).

5. The method of claim 3 wherein the complex pooling comprises calculating an arithmetic mean value
$$( \frac{Σ {a}_{k}}{N} + i \frac{Σ {b}_{k}}{N} )$$
for a sub region array of N elements (aₖ+ibₖ) by summing the elements and dividing by the number of elements in the sub region array.

6. The method of claim 3 wherein the complex pooling comprises striding, selecting a median, selecting a geometric mean, selecting a weighted average or combinations thereof.

7. The method of claim 2 further comprising using complex activation functions in an activation layer of the complex convolution neural network.

8. The method of claim 7 wherein the complex activation function comprises setting the value to zero if both the real and imaginary parts are negative: Relu(a+bi)=a+bi if a>0 or b>0 else 0.

9. The method of claim 7 wherein the complex activation function comprises setting the value to zero if the magnitude is below than a minimum threshold value (such as 0.1) Relu(a+bi)=a+bi if a²+b²>0.1 else 0.

10. The method of claim 7 wherein the complex activation function comprises setting the value to zero if both the real and imaginary parts are negative or if the magnitude is below than a minimum threshold value: Relu(a+bi)=a+bi if (a>0 or b>0) and a²+b²=0.1 else 0.

11. The method of claim 7 wherein the complex activation function comprises applying the function: Relu(a+bi)=(1/2)·(1+cos ϕ)·a+(1/2)·(1+cos ϕ)·bi, where ϕ=arctan(b/a).

12. The method of claim 1 wherein the step of using a complex convolution neural network to process the complex convoluted slices comprises generating an output feature map matrix.

13. The method of claim 12 wherein the complex image data comprises a phase space complex image data matrix M including a real component M_{R} and an imaginary complex component M_{I} and the output feature map matrix M′ is generated by applying a complex kernel matrix K including a real component K_{R} and an imaginary complex component K_{I} such that
$${M}^{′} = M * K = ( {M}_{R} + i {M}_{I} ) * ( {K}_{R} + i {K}_{I} ) = ( {M}_{R} * {K}_{R} - {M}_{I} * {K}_{I} ) + i ( {M}_{R} * {K}_{I} + {M}_{I} * {K}_{R} ) .$$

14. The method of claim 1 further comprises storing, in a database, one or more of the raw complex images received by the receiver, the convoluted slices generated by the pre-processing unit and an identification of the detected concealed object.

15. The method of claim 14 further comprises training the processing unit for detecting the concealed objects using the information stored in the database.

16. The method of claim 15, wherein the training of the processing unit for detecting the concealed objects is done using a Machine Learning (ML) algorithm.

17. The method of claim 1 further comprises transmitting, by a communicator, a notification of the detected concealed object to one or more concerned authorities through a communication network.

18. The method of claim 14 further comprises detecting, by an anomaly detector, deviation of the detected concealed object from a standard identification stored in the database.

19. The method of claim 18, wherein the detected deviation is indicative of detection of non-specific concealed objects.

20. The method of claim 1 further comprises detecting, by the processing unit, at least one of a position of the concealed object within the target subject, a size of the concealed object, and a shape of the concealed object.
